(19) United States
(12) Patent Application Publication
(10) Pub. No.: US 2023/0266266 A1
(43) Pub. Date: Aug. 24, 2023

(54) INTEGRATED BIOSENSOR STRUCTURE AND MANUFACTURING METHOD THEREOF

(71) Applicant: BIOUP LABS TAIWAN CO., LTD., HSINCHU COUNTY (TW)

(72) Inventor: KUN LUNG CHEN, XINZHU COUNTY (TW)

(21) Appl. No.: 18/049,420

(22) Filed: Oct. 25, 2022

Related U.S. Application Data
(60) Provisional application No. 63/313,532, filed on Feb. 24, 2022.

(51) Int. Cl. G01N 27/414

(52) U.S. Cl. CPC G01N 27/4145; G01N 27/4148

(57) ABSTRACT

An integrated biosensor structure is provided. The integrated biosensor structure includes a CMOS structure and a sensing oxide layer. The CMOS structure includes a substrate having a first surface, the substrate includes a sensing region and a logic region surrounding the sensing region; a FEOL structure having a plurality of doped regions at the first surface of the substrate; and a BEOL structure over the FEOL structure. The BEOL structure includes a first trench penetrating the BEOL structure. The sensing oxide layer is disposed over the BEOL structure and in contact with the sensing region of the substrate through the first trench. The sensing oxide layer is conformal with the first trench of the BEOL structure to form a sensing trench. A method of manufacturing an integrated biosensor structure is also provided.

### PRIORITY CLAIM AND CROSS-REFERENCE

This application claims the benefit of prior-filed U.S. Provisional Application No. 63/313,532, filed Feb. 24, 2022, and incorporates its entirety herein.

### FIELD

The present disclosure relates to an integrated biosensor structure and manufacturing method thereof, particularly, the disclosed biosensor structure is an integrated biosensor structure which formed on a complementary metal-oxide-semiconductor (CMOS) chip.

### BACKGROUND

The use of biosensing instruments using disposable sample pieces has been increasing each year, and it is expected to enable simple and quick assay and analysis of a particular component in a biological body fluid such as blood, plasma, urine, saliva, or the whole set of proteins created in a cell at a certain point in time, i.e., a proteome. Moreover, individually tailored medical treatments, in which individuals are treated and administered medicines according to their SNP (acronym for Single Nucleotide Polymorphism) information, are expected to be put into practice in the future by genetic diagnosis using disposable DNA chips.

### BRIEF DESCRIPTION OF THE DRAWINGS

Aspects of the present disclosure are best understood from the following detailed description when read with the accompanying figures. It is noted that, in accordance with the standard practice in the industry, various structures are not drawn to scale. In fact, the dimensions of the various structures may be arbitrarily increased or reduced for clarity of discussion.

FIG. 1 illustrates a cross-sectional view of a FET-based biosensor according to some comparative embodiments of the present disclosure.

FIG. 2 illustrates a cross-sectional view of a SOI-based biosensor according to some comparative embodiments of the present disclosure.

FIG. 3 illustrates a cross-sectional view of an integrated biosensor structure according to some embodiments of the present disclosure.

FIG. 4 illustrates a cross-sectional view of an integrated biosensor structure according to some embodiments of the present disclosure.

FIG. 5 illustrates a cross-sectional view of an integrated biosensor structure according to some embodiments of the present disclosure.

FIG. 6 illustrates a layout of an integrated biosensor structure according to some embodiments of the present disclosure.

FIGS. 7A to 7E illustrate cross-sectional views of forming a semiconductor structure according to some embodiments of the present disclosure.

FIGS. 8A to 8G illustrate cross-sectional views of forming a semiconductor structure according to some embodiments of the present disclosure.

### DETAILED DESCRIPTION

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper”, “on” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the terms such as “first”, “second” and “third” describe various elements, components, regions, layers and/or sections, these elements, components, regions, layers and/or sections should not be limited by these terms. These terms may be only used to distinguish one element, component, region, layer or section from another. The terms such as “first”, “second”, and “third” when used herein do not imply a sequence or order unless clearly indicated by the context.

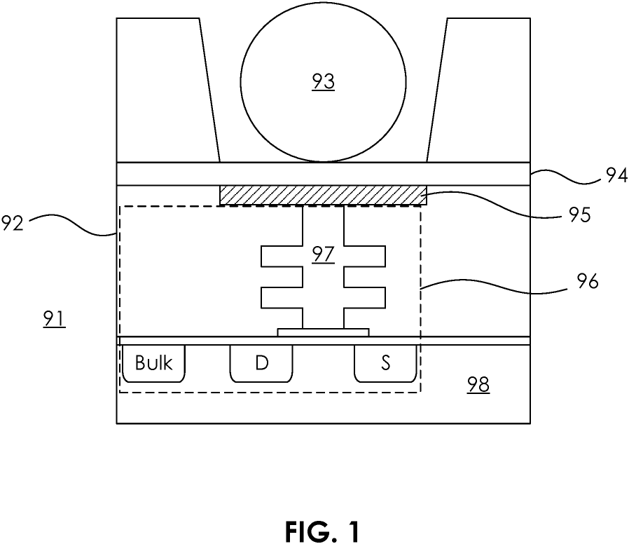

In some comparative embodiments, biosensors are formed over an ion-sensitive field-effect transistor (ISFET) or formed through SOI technology. As a FET-based biosensor 91 shown in FIG. 1, in the scenario that a biosensor structure is formed with an ISFET structure (i.e., a FET-based biosensor), a sample 93 can be placed in contact with a metal-oxide-sensing layer 94 over a metal sensor plate 95 of the ISFET structure 92. The signal generated by the interaction between the metal-oxide-sensing layer 94 and the sample 93 can be transmitted to a transistor portion 96 of the ISFET structure 92 through a floating metal gate structure 97 below the metal sensor plate 95.

In the FET-based biosensor 91 shown in FIG. 1, because the transistor portion 96 of the ISFET structure 92 is formed at a top side of a silicon substrate 98 of the FET-based biosensor 91, and the floating metal gate structure 97, the metal sensor plate 95, and the metal-oxide-sensing layer 94 are subsequently formed over the silicon substrate 98, thus a path for signal transmission through the abovementioned structures is comparatively distanced. Therefore, the sensitivity of these FET-based biosensors 91 is limited to a certain degree due to such structural restrictions.

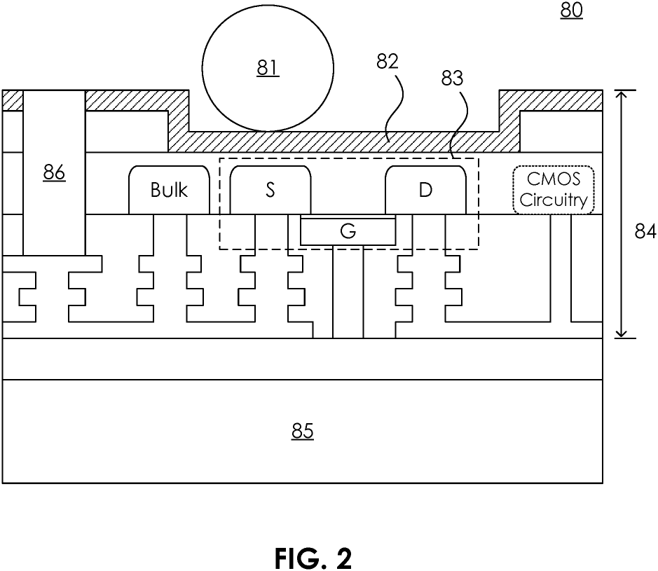

In another comparative embodiment, biosensors can be formed through SOI technology (hereinafter “SOI-based biosensor”). In such embodiments, as an SOI-based biosensor 80 shown in FIG. 2, a sample 81 can be placed in contact with an oxide sensing layer 82 in proximity to the source/drain regions of a transistor structure 83 in a device substrate 84 of the SOI structure. Since a sensing region (i.e., the oxide sensing layer 82) of the SOI-based biosensor 80 is in proximity to the source/drain regions of the transistor structure 83, the sensitivity would be theoretically better than the FET-based biosensor 91 previously shown in FIG. 1. However, because the device substrate 84 has to be bonded with a handle wafer 85 and there are several TSV pads 86 have to be fabricated in the device structure 84, thus both the cost and the yield in manufacturing such SOI-based biosensor 80 are not attractive. Furthermore, even though the V_{T} shift of the SOI-based biosensor 80 is comparatively high, but in the case of using the current shift of the SOI-based biosensor 80 in evaluating the sensitivity of the biosensor, the advantage of the SOI-based biosensor 80 would vanish accordingly.

Therefore, a biosensor having good sensitivity and an acceptable manufacturing cost is provided by some embodiments of the present disclosure. That is, the present disclosure discloses an integrated biosensor structure and that the sensing structure is directly formed on a CMOS structure, which can make the biosensor perform the features of good sensitivity, and the manufacturing cost thereof is acceptable as well.

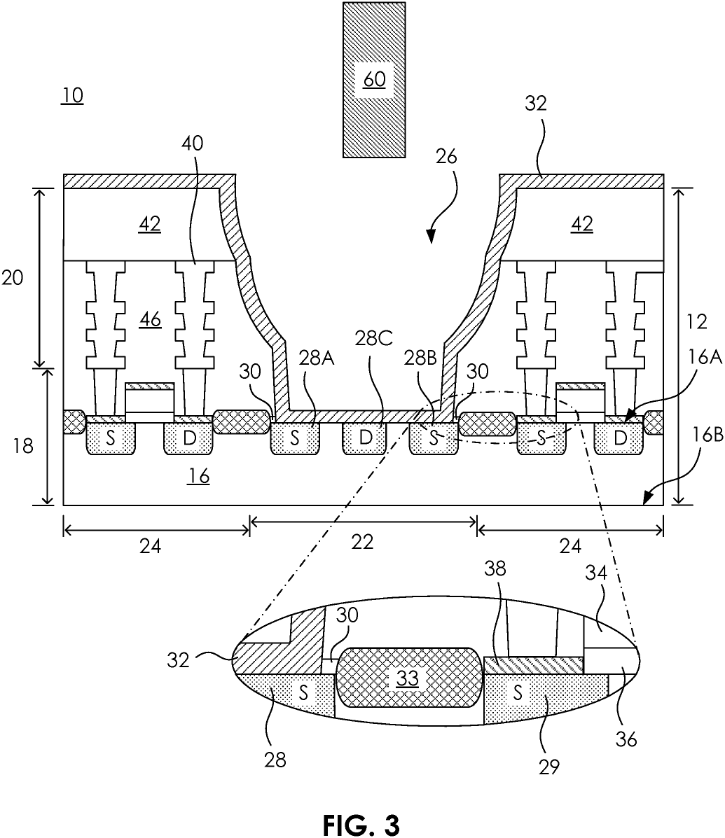

FIG. 3 illustrates an integrated biosensor structure 10 according to some embodiments of the present disclosure. As shown in the figure, the integrated biosensor structure 10 includes a CMOS structure 12 and a sensing oxide layer 14 formed over the CMOS structure 12. The CMOS structure 12 includes a substrate 16, and a front-end-of-line (FEOL) structure 18, and a back-end-of-line (BEOL) structure 20 are formed in proximity to a first surface 16A of the substrate 16. In some embodiments, the substrate 16 is a semiconductor substrate made of semiconductor materials such as silicon, germanium, diamond, or the like. Alternatively, in other embodiments, compound materials such as silicon germanium, silicon carbide, gallium arsenic, indium arsenide, indium phosphide, silicon germanium carbide, gallium arsenic phosphide, gallium indium phosphide, combinations thereof, and the like, may also be used to form the substrate 16.

In some embodiments, the substrate 16 includes different regions configured to perform different functions. As shown in FIG. 3, in such embodiment, the substrate 16 includes a sensing region 22 and a logic region 24 surrounding the sensing region 22. In the present disclosure, the meanings of these regions can be vertically extended, for example, the structures that formed over the sensing region 22 of the substrate 16 can be identified as “within the sensing region 22”, and so does the logic region 24. The sensing region 22 is configured to form a sample-holding structure for the sensing purpose, whereas the logic region 24 is configured to form an interconnect structure for the electrical purpose. In some embodiments of the present disclosure, the sample-holding structure within the sensing region 22 is substantially leveled with the interconnect structure within the logic region 24. In other words, the path for signal transmission in some embodiments of the present disclosure can be shortened by excluding the interconnect structure from the path between the sample-holding structure and a sensing structure (e.g., a doped region within the sensing region 22). More details are disclosed as follows.

In some embodiments, the FEOL structure 18 can be formed in/on the substrate 16. In some embodiments, the FEOL structure 18 has a plurality of doped regions at the first surface 16A of the substrate 16. In some embodiments, a portion of the doped regions (e.g., the first doped regions 28) are located within the sensing region 22, while another portion of the doped regions (e.g., the second doped regions 29) are located within the logic region 24. In some embodiments, the doped regions located within the sensing region 22 are configured to perform as terminals in receiving or sensing the change of potential (ΔV) induced by a sensing layer thereon. For example, in the case of the integrated biosensor structure 10 in the present disclosure is used for DNA sequencing, particularly, for non-optical DNA sequencing, a DNA template can be accommodated in the sample-holding structure within the sensing region 22. Then, protons (H+) are released when nucleotides (dNTP) are incorporated into the growing DNA strands, changing the pH of the medium in the sample-holding structure (ΔpH). This progress can induce a change in the surface potential of the sensing layer and a change in the potential (ΔV) of the source terminal in the substrate 16.

Other than the portion of the doped regions located within the sensing region 22, the doped regions within the logic region 24 are configured to perform the functions of the terminals of field-effect transistors (FET), which means these doped regions can be a portion of the transistors within the logic region 24, and generally, these transistors are connected to the BEOL structure 20 thereover. In some embodiments, the signals acquired from the sensing region 22 can be transmitted to other semiconductor devices (e.g., an amplifier circuit) by the structures in the logic region 24.

As shown in FIG. 3, in some embodiments, the BEOL structure 20 over the FEOL structure 18 includes a first trench 26 exposing the sensing region 22 of the substrate 16. The first trench 26 can be called a well or a nanowell, depending on the size thereof. In some embodiments, as the example shown in FIG. 3, the doped regions such as the source regions 28A, 28B and the drain region 28C are exposed at a bottom of the first trench 26 (these source/drain regions are exposed in the CMOS structure 12, but the CMOS structure 12 is further be covered by a sensing oxide layer 32, which will be discussed later). In some embodiments, the bottom of the first trench 26 is substantially identical to or coplanar with the first surface 16A of the substrate 16.

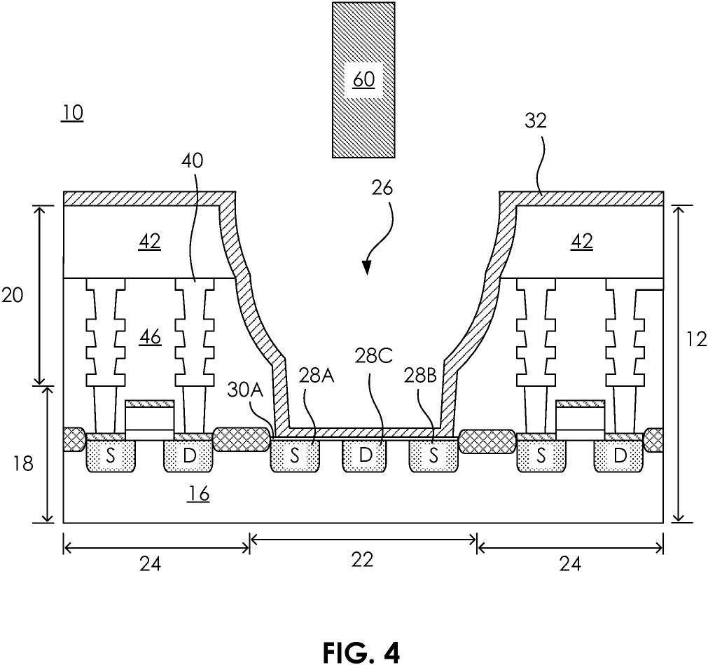

In other embodiments, as shown in FIG. 4, each of the doped regions within the sensing region 22 such as source regions 28A, 28B, and a drain region 28C are not entirely exposed at the bottom of the first trench 26 due to the coverage of a thin first gate oxide 30A. The first gate oxide is a gate dielectric layer of a gate structure, which is formed under a gate electrode of the gate structure. The gate dielectric layer may be made of silicon oxide, silicon nitride, or a high dielectric constant material (high-k material). In some embodiments, the gate dielectric layer is formed by a chemical vapor deposition (CVD) operation. In some embodiments of the present disclosure, the gate dielectric layer is made of silicon oxide, thus called gate oxide hereinafter.

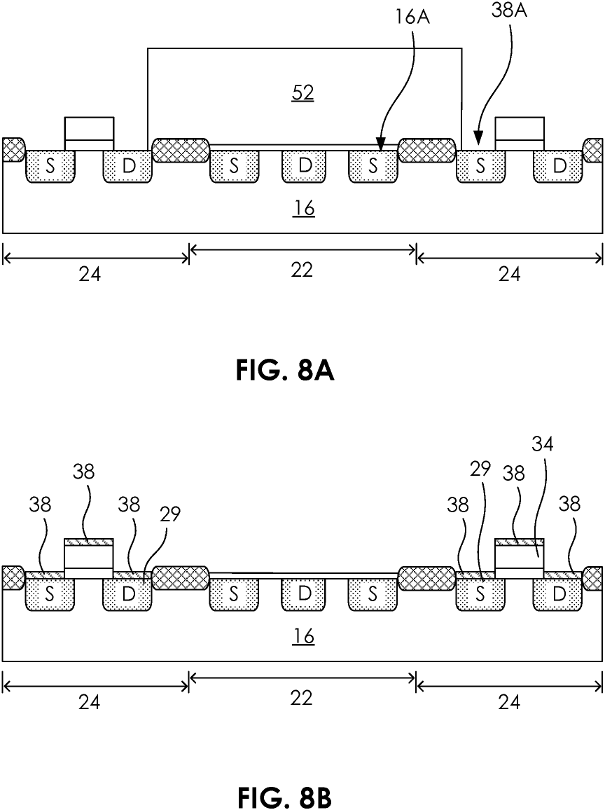

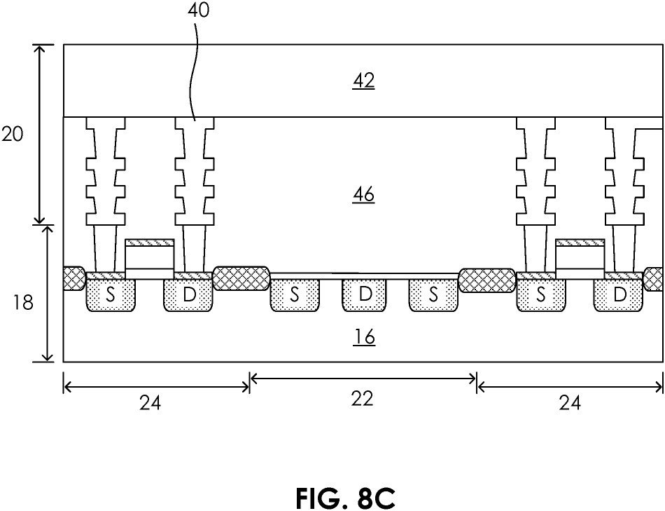

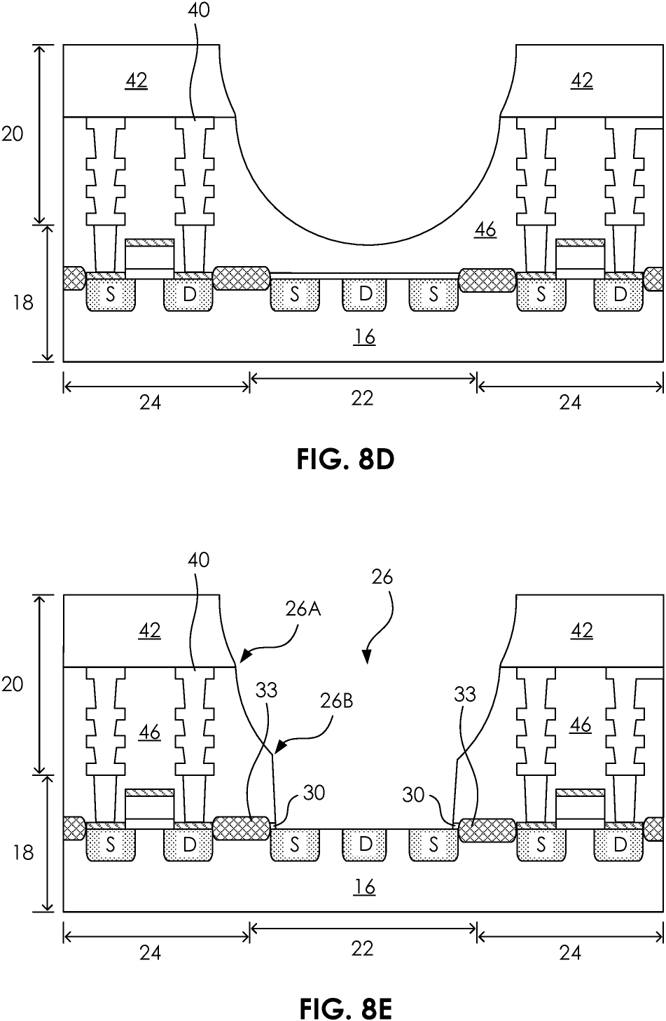

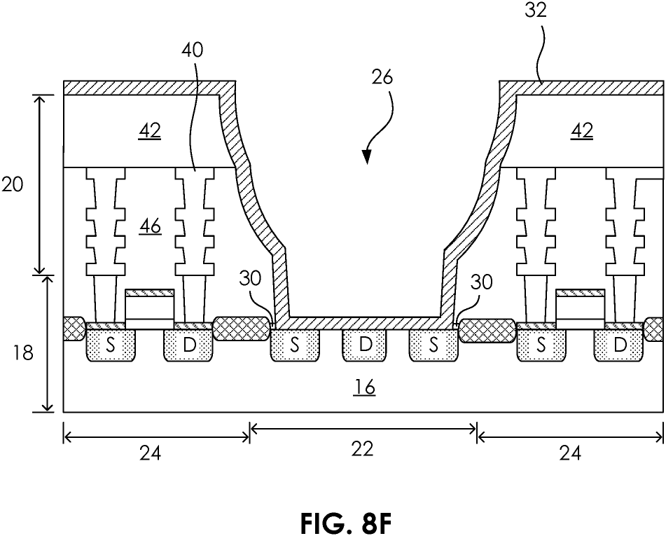

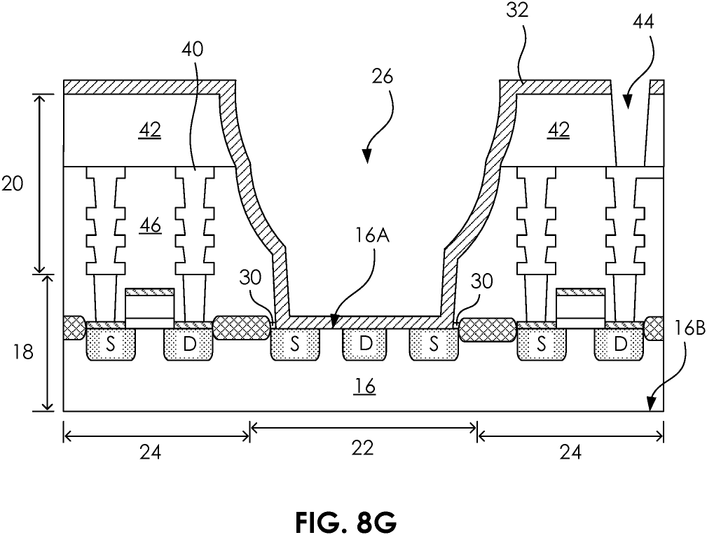

The gate electrode that formed over the gate oxide may be made of polysilicon (POLY) or any other suitable conductive material. The suitable conductive material includes but is not limited to metal (e.g., tantalum, titanium, molybdenum, tungsten, platinum, aluminum, hafnium, ruthenium), metal silicide (e.g., titanium silicide, cobalt silicide, nickel silicide, tantalum silicide), or metal nitride (e.g., titanium nitride, tantalum nitride). In some embodiments, the gate electrode is formed by chemical vapor deposition (CVD), low-pressure chemical vapor deposition, physical vapor deposition (PVD), atomic layer deposition, or spin-on. In some embodiments, the gate structure is formed by forming the gate electrode on the gate oxide, and then patterning the gate electrode by etching to form the gate structure. In some embodiments of the present disclosure, the first gate oxide 30 is thinned down after a removing operation to a polysilicon gate electrode formed thereon, and such thin first gate oxide 30A can be used as an etch stop layer in removing the poly gate electrode to protect the intactness of the doped regions there below within the sensing region 22. In some embodiments, the first gate oxide 30 can be removed in the operation of forming the first trench 26 prior to forming a sensing oxide layer 32 thereon, more details may refer to the operations later shown in FIGS. 8D to 8E.

In some embodiments, a portion of the first gate oxide 30 can be removed in the operation of forming the first trench 26 prior to forming the sensing oxide layer 32 thereon, while another portion of the first gate oxide 30, or called a first gate oxide residue, is adjacent to an edge of the first trench 26, particularly, as shown in the enlarged portion in FIG. 3. In some embodiments, a side of the first gate oxide (residue) 30 is exposed at a corner portion of the first trench 26 to be in contact with the sensing oxide layer 32. That is, in order to well protect the doped regions within the sensing region 22 during the manufacturing process, the boundary of the first trench 26 can land over the doped region within the sensing region 22, and therefore the first gate oxide 30 is partially removed, and the first gate oxide residue is left near the edge of the sensing region 22.

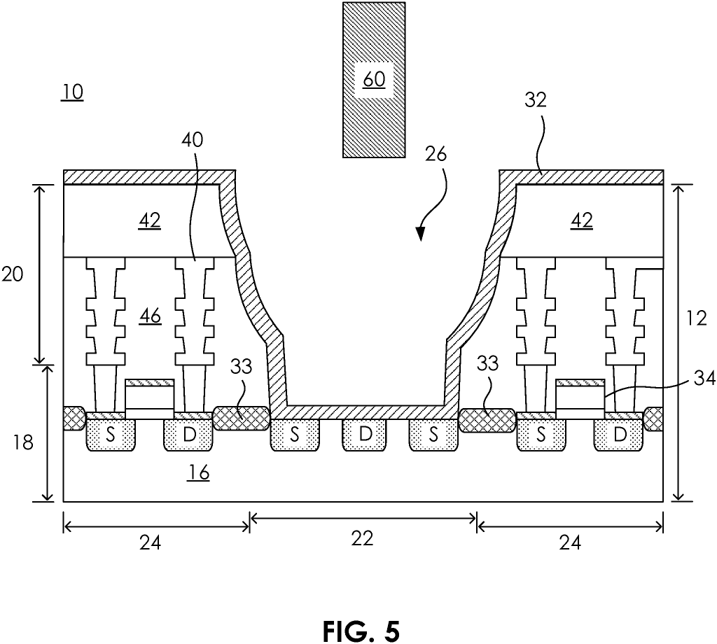

In other embodiments, as shown in FIG. 5, the edge of the first trench 26 is aligned with an edge of a field oxide 33, and therefore the first gate oxide 30 can be removed entirely in the operation of forming the first trench 26.

As shown in FIGS. 3-5, the structure features within the logic region 24 can be the same. In some embodiments, a plurality of poly gate structures 34 are formed over the doped regions within the logic region 24. In some embodiments, a second gate oxide 36 can be formed between the first surface 16A of the substrate 16 and each of the plurality of poly gate structures 34. In some embodiments, each of the plurality of poly gate structures 34 and a least a portion of each of the doped regions within the logic region 24 are covered by a silicide layer 38. In some embodiments, there are at least two second gate oxides 36 over the logic region 24 of the substrate 16, the two second gate oxides 36 are located at two sides of the first trench 26, respectively.

In some embodiments, the sensing oxide layer 32 is formed over the BEOL structure 20 and in contact with the first surface 16A within the sensing region 22 of the substrate 16. That is, the sensing oxide layer 32 can be formed over the BEOL structure 20 within the logic region 24, while the first trench 26 is formed within the sensing region 22, the structure of the sensing oxide layer 32 is conformal with the profile of first trench 26 to form a sensing trench within the sensing region 22. In some embodiments, the sensing oxide layer 32 comprises hafnium oxide (HfOₓ). In some embodiments, the thickness of the sensing oxide layer 32 is about 3 µm. In some embodiments, since the inner sidewall of the first trench 26 does not include a continuous planar profile due to an altar of the etching operation in forming the first trench 26, the profile of the sensing oxide layer 32 in the first trench 26 includes at least a change of slope along the inner sidewall of the first trench 26. The details of the method of manufacturing an integrated biosensor structure will be disclosed later.

In some embodiments, the integrated biosensor structure 10 further includes an electrode 60 disposed over the sensing trench, the electrode 60 is configured to be in contact with a medium located in the sensing trench. The sample for sensing in the present disclosure is carried by the medium or be placed directly within the sensing trench and in contact with the sensing oxide layer 32. In some embodiments, the sample is a fluidic biomedical sample, such as DNA containing fluids, blood, interstitial fluid in subcutaneous tissue, muscle or brain tissue, urine, or other body fluids.

In some embodiments, the silicide layer 38 is not formed within the sensing region 22, thus each of the doped regions free from in contact with the sensing oxide layer 32 is covered by a silicide layer 38. That is, silicide is a compound of silicon with metal, and therefore the silicide layer 38 can ensure low contact and series resistance to the source and drain region of the transistor within the logic region 24, whereas the doped regions within the sensing region 22 (i.e., the first doped regions 28) do not need to have conductive contacts and metallization structures thereon, hence there is no silicide layer 38 formed within the sensing region 22.

In some embodiments, within the logic region 24, a metallization structure 40 is formed over the plurality of poly gate structures 34 and the plurality of second doped regions 29. In some embodiments, since the silicide layer 38 is formed to cover the plurality of poly gate structures 34 and the second doped regions 29 within the logic region 24, the conductive contacts of the metallization structure 40 can be landed on the top surface of the silicide layer 38. In some embodiments, the metallization structure 40 includes four metal layers connected by a plurality of conductive vias therebetween, however, the number of the metal layers is not a limitation of the present embodiments.

In some embodiments, the logic region 24 includes a passivation layer 42 formed over the metallization structure 40. The passivation layer 42 may be made of undoped silicate glass (USG), silicon oxynitride, phosphosilicate glass (PSG), borophosphosilicate glass (BPSG), fluorinated silicate glass (FSG), organosilicate glasses (OSG), SiOₓC_{y}, Spin-On-Glass, or the like. In some embodiments, the passivation layer 42 is formed by high density plasma (HDP), chemical vapor deposition (CVD), plasma-enhanced CVD, sputter, spin-on, physical vapor deposition (PVD), or other applicable methods.

In some embodiments, the sensing oxide layer 32 as previously mentioned can be formed over the passivation layer 42. In some embodiments, the sensing oxide layer 32 is in contact with the passivation layer 42. In some embodiments, the sensing oxide layer 32 in the sensing region 22 extends to the logic region 24 along a side of the metallization structure 40 and a side of the passivation layer 42. In some embodiments, the slope of the side of the first trench 26 (or the slope of the sensing oxide layer 32) is changed due to a change in the etching operations. For example, in forming the first trench 26 that penetrates the passivation layer 42 and the metallization structure 40, an isotropic etching operation can be applied at the very beginning in etching the passivation layer 42 and a portion of the metallization structure 40, and then an anisotropic etching operation can be applied to etch the remained metallization structure 40 to expose the first surface 16A of the substrate 16 within the sensing region 22.

In some embodiments, the integrated biosensor structure 10 includes a second trench 44 over a drain region within the logic region 24. The second trench 44 is leveled with the passivation layer 42 over the logic region 24 of the substrate 16. In some embodiments, the second trench 44 is formed to expose a top of the metallization structure 40 for bumping.

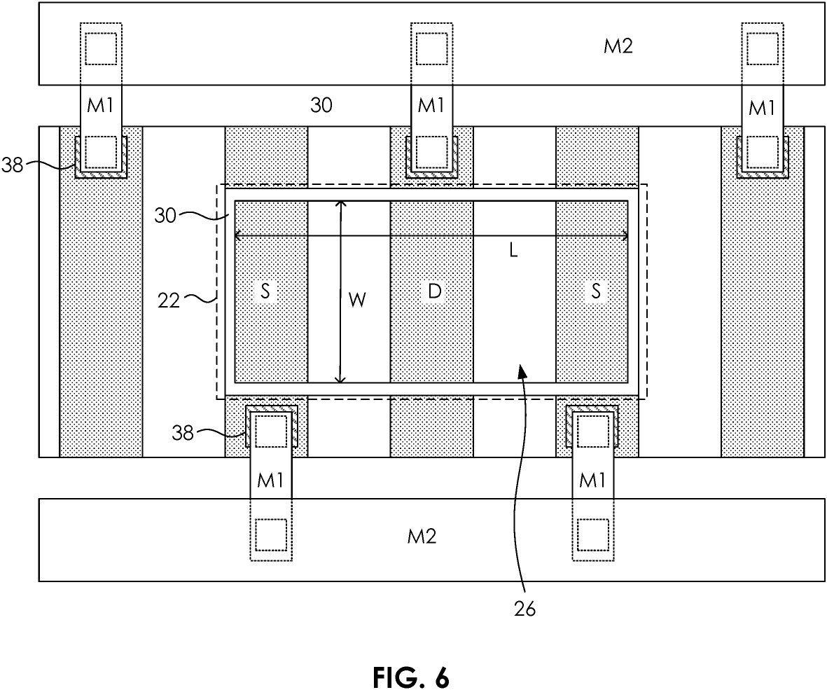

FIG. 6 is a layout of a portion of the integrated biosensor structure 10 according to some embodiments of the present disclosure, while the figure only illustrates some of the structures of the embodiment for brevity. In some embodiments, a wide W or a length L of the first trench 26 is about 100 µm.

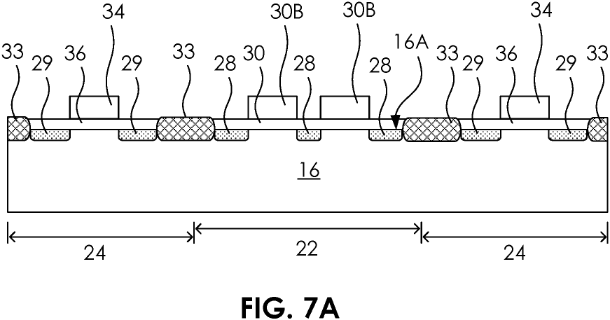

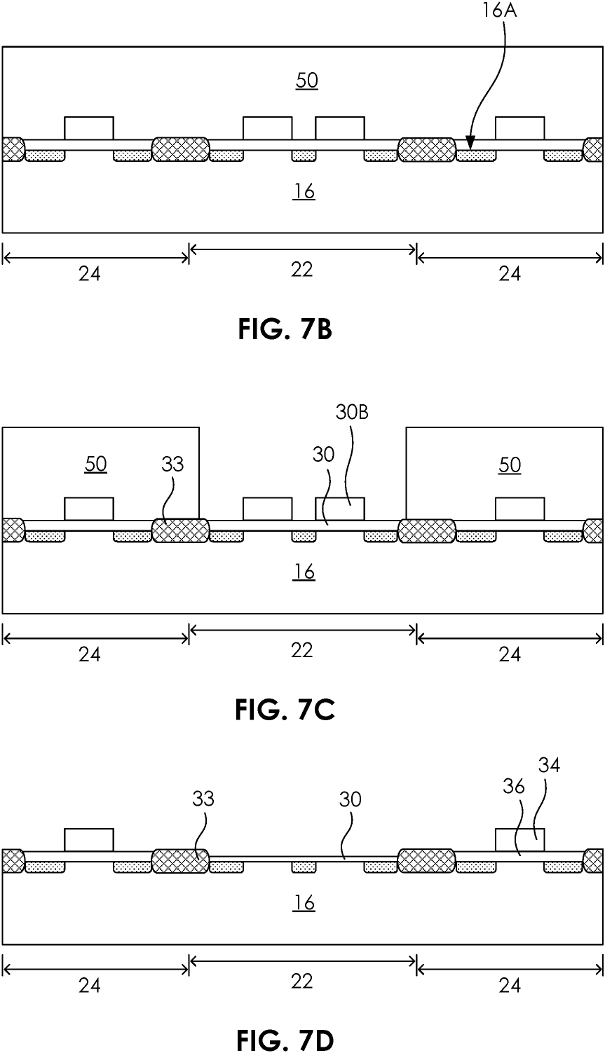

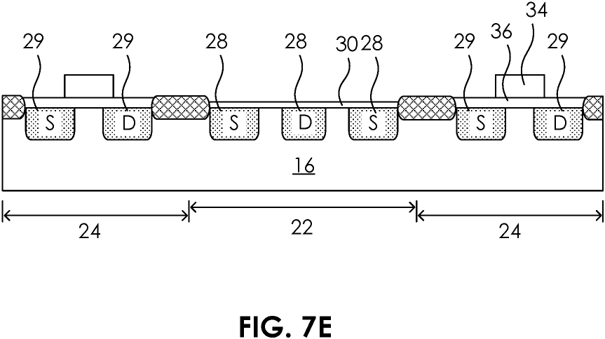

In manufacturing the semiconductor structure as shown in FIG. 3, the operations thereof may refer to FIGS. 7A to 7E and FIGS. 8A to 8G. As shown in FIG. 7A, in some embodiments, the substrate 16 having one or more first gate oxides 30 and one or more second gate oxide 36 over the first surface 16A of the substrate 16 is received. A plurality of first doped regions 28 and a plurality of second doped regions 29 can be formed by an implanting operation, and the boundaries of the plurality of the first doped regions 28 and the plurality of second doped regions 29 can be self-aligned to the sides of the first gate oxides 30, the second gate oxides 36, or some field oxides 33 on/at the first surface 16A of the substrate 16. In some embodiments, the first doped regions 28 are the doped regions that formed within the sensing region 22 of the substrate 16, while the second doped regions 29 are the doped regions that formed within the logic region 24 of the substrate 16. These doped regions can be N-doped or P-doped. For example, in some other portions of the substrate 16, it may be doped with a p-type dopant such as boron, boron fluorine, aluminum, gallium, or the like, whereas in some other portions of the substrate 16, it may alternatively be doped with an n-type dopant such as phosphorus, arsenic, antimony, or the like. As the positions of the doped regions, the first gate oxides 30 are the gate oxides that formed within the sensing region 22 of the substrate 16, while the second gate oxides 36 are the gate oxides that formed within the logic region 24 of the substrate 16. Moreover, a plurality of first poly gate structures 30B and a plurality of second poly gate structures 34 are already prepared on the first gate oxides 30 and the second gate oxides 36, respectively.

Next, as shown in FIGS. 7B to 7D, in some embodiments, a first photoresist layer 50 can be formed over the first surface 16A of the substrate 16, and further be patterned to expose the first gate structures (i.e., the first gate oxides 30 and the first poly gate structures 30B) within the sensing region 22. The first photoresist layer 50 is used to block the logic region 24 and to remove the polysilicon within the sensing region 22.

By exposing the first gate structures within the sensing region 22 of the substrate 16, as shown in FIG. 7D, the first poly gate structures 30B can be removed by an etching operation. Moreover, in some embodiments, not only the first poly gate structures 30B are removed, but the thickness of each of the first gate oxides 30 can also be reduced slightly due to the etching operation, and therefore the thickness of each of the first gate oxides 30 is different from the thickness of each of the second gate oxide 36. That is, the thickness of each of the first gate oxides 30 is less than the thickness of each of the second gate oxide 36. The first photoresist layer 50 can be removed after the first poly gate structures 30B are removed.

As shown in FIG. 7E, in some embodiments, a driving-in operation can be applied to the plurality of first doped regions 28 and the plurality of second doped regions 29. The drive-in operation is to control the profile of these doped regions during the diffusion of the implanted ions.

Then, as shown in FIGS. 8A and 8B, which illustrate the cross-section view of the structure along the line including the one or more silicide block 38A for forming silicide layers, in some embodiments, a second photoresist layer 52 can be formed and patterned over the first surface 16A of the substrate 16 within the sensing region 22. The second photoresist layer 52 is used to block the sensing region 22 from forming the silicide layer 38. The silicide layer 38 can be formed and self-aligned over the second gate oxide 36 (e.g., formed on the top of the second poly gate structures 34) and the plurality of second doped regions 29 by using the reaction between the metal deposited thereon and implementing an annealing operation. The unreacted metal, some byproducts, and the second photoresist layer 52 can be removed after the above-mentioned self-aligned process in forming the silicide layer 38.

Referring to FIG. 8C, in some embodiments, a CMOS back-end operation can be performed to form the BEOL structure 20 over the first surface 16A of the substrate 16. In some embodiments, the BEOL structure 20 includes the metallization structure 40. Generally, the BEOL structure 20 is defined as the structure that does not lower than the first metal layer (M1) of the metallization structure 40, and the conductive contacts and the transistor structures below belong to the middle-of-line (MOL/MEOL) structure and the FEOL structure 18. The metallization structure 40 includes a series of stacked metal layers connected through the use of conductive contacts and vias. These metal layers and conductive contacts and vias can be surrounded by an interlayer dielectric (ILD) 46. In some embodiments, the metal layers and the conductive contacts and vias are not formed within the sensing region 22, and therefore the space within the sensing region 22 can be entirely filled by the ILD 46 prior to forming the first trench 26. Furthermore, after the metallization structure 40 is formed, the passivation layer 42 can be formed over the metallization structure 40.

Referring to FIGS. 8D and 8E, in some embodiments, the first trench 26 can be formed within the sensing region 22. In some embodiments, the metallization structure 40 and the passivation layer 42 within the sensing region 22 can be mostly removed by a two-stage etch operation. That is, in forming the first trench 26, as shown in FIG. 8D, a wet etching operation can be implemented to at least etch through the passivation layer 42; next, a dry etching operation can be implemented to etch the ILD 46 to expose the structures below the ILD 46 of the metallization structure 40 within the sensing region 22.

In some embodiments, the material of the passivation layer 42 is silicon nitride, whereas the material of the ILD 46 is silicon oxide, and thus the profile of the first trench 26 can have a first change point 26A at the interface between the passivation layer 42 and the ILD 46 due to the different etch ratio thereof. In some embodiments, the profile of the first trench 26 can have a second change point 26B at the level of the ILD 46 since the etching technique is changed from a wet etching (or an isotropic) to a dry etching (or an anisotropic). In some embodiments, an amount of the ILD 46 etched by isotropic etching operation is greater than an amount of the ILD 46 etched by anisotropic etching. In some embodiments, most of the first gate oxide 30 can be removed during the dry etching operation. In other words, in some embodiments, the first gate oxide 30 can be preserved at a corner portion of the first trench 26. These first gate oxides 30 are not etched because the boundary of the first trench 26 should be landed over the first gate oxides 30 instead of the field oxides 33; otherwise, the field oxides 33 might be damaged during the etching operation and result in unwanted current leakage. Accordingly, the footing of the first trench 26 should be designed to be landed within the area between the field oxides 33, and a portion of the first gate oxide 30 can thus remain for the buffering purpose. In some embodiments, a side of the first trench 26 is composed of first gate oxide 30, particularly, around the lowermost side of the first trench 26. In some embodiments, the plurality of first doped regions 28 can be exposed by forming the first trench 26.

Referring to FIG. 8F, in some embodiments, the sensing oxide layer 32 can be formed subsequently after the formation of the first trench 26. The structure of the sensing oxide layer 32 can conformal to the profile of the top surface of the passivation layer 42 and the side surface and the bottom surface of the first trench 26. In some embodiments, the thickness of the sensing oxide layer 32 is about 3 µm. In some embodiments, the material of the sensing oxide layer 32 includes hafnium oxide. In some embodiments, in order to form the thin hafnium oxide layer, the hafnium oxide can be deposited over the passivation layer 42 and the side surface and the bottom surface of the first trench 26, and then a sintering operation can be implemented to sinter them into high-density ceramic materials. In some embodiments, the sensing oxide layer 32 is in contact with the first gate oxide 30 near the lowermost side of the first trench 26.

Referring to FIG. 8G, in some embodiments, the second trench 44 can be formed at the passivation layer 42 to expose a portion of the metallization structure 40 for the following bumping operation. Since the metal layers and the conductive contacts and vias are formed within the logic region 24, the second trench 44 is formed within the logic region 24 as well, so that a top surface of a top metal layer of the metallization structure 40 can be exposed accordingly.

In some embodiments, a second surface 16B opposite to the first surface 16A of the substrate 16 is free from having a conductive via in proximity to the second surface 16B. That is, the substrate 16 in the present disclosure is not a portion of an SOI structure that have to be bonded with a handle wafer, thus there are no conductive vias (e.g., TSV) need to be fabricated in proximity to the second surface 16B of the substrate 16. Accordingly, the cost and the yield issues induced by the SOI-based biosensor can be avoided thereby. Meanwhile, since the sensing oxide layer 32 is very close to the source/drain regions within the sensing region 22 of the substrate 16, hence the sensitivity would be better than the FET-based biosensor. Overall, the integrated biosensor structure 10 disclosed in the present disclosure includes the advantages of high sensitivity, low cost, high yield in manufacturing, and entirely capable with the mature CMOS process.

In one exemplary aspect, an integrated biosensor structure is provided. The integrated biosensor structure includes a CMOS structure and a sensing oxide layer. The CMOS structure includes a substrate having a first surface, the substrate includes a sensing region and a logic region surrounding the sensing region; a FEOL structure having a plurality of doped regions at the first surface of the substrate; and a BEOL structure over the FEOL structure. The BEOL structure includes a first trench penetrating the BEOL structure. The sensing oxide layer is disposed over the BEOL structure and in contact with the sensing region of the substrate through the first trench. The sensing oxide layer is conformal with the first trench of the BEOL structure to form a sensing trench.

In another exemplary aspect, an integrated biosensor structure is provided. The integrated biosensor structure includes a substrate having a first surface. The substrate includes a sensing region and a logic region surrounding the sensing region. The sensing region includes a plurality of first doped regions at the first surface of the substrate; and a sensing oxide layer over the plurality of first doped regions. The sensing oxide layer and the first surface of the substrate are free from having a metallization structure there between. The logic region includes a plurality of second doped regions at the first surface of the substrate; a plurality of gate structures over the plurality of second doped regions; and a metallization structure over the plurality of gate structures.

In yet another exemplary aspect, a method of manufacturing an integrated biosensor structure is provided. The method includes the following operations: a substrate having a first gate oxide and a second gate oxide over a first surface of the substrate is received; a plurality of first doped regions and a plurality of second doped regions are formed at the first surface of the substrate; the first gate oxide is thinned down; a silicide layer is formed over the second gate oxide and the plurality of second doped regions; a metallization structure is formed over the plurality of second doped regions, the plurality of first doped regions are covered by a dielectric material of the metallization structure; the dielectric material of the metallization structure is etched to form a first trench to expose the plurality of first doped regions; and a sensing oxide layer is formed over the plurality of first doped regions.

The foregoing outlines structures of several embodiments so that those skilled in the art may better understand the aspects of the present disclosure. Those skilled in the art should appreciate that they may readily use the present disclosure as a basis for designing or modifying other operations and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An integrated biosensor structure, comprising:
a CMOS structure, comprising:
a substrate having a first surface, the substrate comprises a sensing region and a logic region surrounding the sensing region;
a front-end-of-line (FEOL) structure having a plurality of doped regions at the first surface of the substrate; and
a back-end-of-line (BEOL) structure over the FEOL structure, the BEOL structure comprises a first trench penetrating the BEOL structure; and
a sensing oxide layer over the BEOL structure and in contact with the sensing region of the substrate through the first trench;
wherein the sensing oxide layer is conformal with the first trench of the BEOL structure to form a sensing trench.

2. The integrated biosensor structure of claim 1, wherein the sensing oxide layer comprises hafnium oxide.

3. The integrated biosensor structure of claim 1, wherein each of the doped regions free from in contact with the sensing oxide layer is covered by a silicide layer.

4. The integrated biosensor structure of claim 1, further comprising a first gate oxide over the sensing region of the substrate, wherein the first gate oxide is adjacent to an edge of the first trench.

5. The integrated biosensor structure of claim 4, further comprising at least two second gate oxides over the logic region of the substrate, wherein the two second gate oxides are located at two sides of the first trench.

6. The integrated biosensor structure of claim 5, wherein a thickness of the first gate oxide is less than a thickness of each of the second gate oxides.

7. The integrated biosensor structure of claim 1, further comprising a second trench over a drain region within the logic region of the substrate, wherein the second trench is leveled with a passivation layer over the logic region of the substrate.

8. The integrated biosensor structure of claim 1, wherein the sensing trench is configured to in contact with a fluidic biomedical sample.

9. The integrated biosensor structure of claim 1, further comprising an electrode disposed over the sensing trench, the electrode is configured to in contact with a medium located in the sensing trench.

10. An integrated biosensor structure, comprising:
a substrate having a first surface, the substrate comprises:
a sensing region, comprising:
a plurality of first doped regions at the first surface of the substrate; and
a sensing oxide layer over the plurality of first doped regions, wherein the sensing oxide layer and the first surface of the substrate are free from having a metallization structure therebetween; and
a logic region surrounding the sensing region, comprising:
a plurality of second doped regions at the first surface of the substrate;
a plurality of gate structures over the plurality of second doped regions; and
a metallization structure over the plurality of gate structures.

11. The integrated biosensor structure of claim 10, wherein the plurality of gate structures in the logic region are leveled with the sensing oxide layer in the sensing region.

12. The integrated biosensor structure of claim 10, wherein the substrate having a second surface opposite to the first surface, the substrate is free from having a conductive via in proximity to the second surface.

13. The integrated biosensor structure of claim 10, wherein the sensing region further comprises a first gate oxide in contact with the first surface of the substrate in the sensing region, the first gate oxide is in contact with a side of the sensing oxide layer.

14. The integrated biosensor structure of claim 13, wherein a thickness of the first gate oxide is different from a thickness of a second gate oxide of each of the plurality of gate structures in the logic region.

15. The integrated biosensor structure of claim 10, wherein the logic region further comprises a passivation layer over the metallization structure, the sensing oxide layer in the sensing region further extends to the logic region along a side of the metallization structure and a side of the passivation layer.

16. The integrated biosensor structure of claim 15, wherein a profile of the sensing oxide layer in the first trench comprises at least a change of slope along an inner sidewall of the first trench.

17. A method of manufacturing an integrated biosensor structure, the method comprising:
receiving a substrate having a first gate oxide and a second gate oxide over a first surface of the substrate;
forming a plurality of first doped regions and a plurality of second doped regions at the first surface of the substrate;
thinning downing the first gate oxide;
forming a silicide layer over the second gate oxide and the plurality of second doped regions;
forming a metallization structure over the plurality of second doped regions, the plurality of first doped regions are covered by a dielectric material of the metallization structure;
etching the dielectric material of the metallization structure to form a first trench to expose the plurality of first doped regions; and
forming a sensing oxide layer over the plurality of first doped regions.

18. The method of claim 17, further comprising:
forming a passivation layer over the metallization structure prior to form the first trench;
forming the sensing oxide layer over the passivation layer; and
forming a second trench at the passivation layer to expose a portion of the metallization structure.

19. The method of claim 17, wherein the dielectric material of the metallization structure is etched by an anisotropic etching operation and an isotropic etching operation, an amount of the dielectric material etched by the isotropic etching operation is greater than an amount of the dielectric material etched by the anisotropic etching operation.

20. The method of claim 19, wherein a thickness of the first gate oxide is thinned to be less than a thickness of the second gate oxide in the thinning down operation.
